(19) United States
(12) Patent Application Publication
(10) Pub. No.: US 2006/0293099 A1
(43) Pub. Date: Dec. 28, 2006

(54) Chipless gaming system and method

(76) Inventor: Steve W. Cooper, Independence, MO (US)

Correspondence Address: DAVID E. HERRON II, PO BOX 2778, KANSAS CITY, KS, 66110, US

(21) Appl. No.: 11/159,896

(22) Filed: Jun. 23, 2005

(51) Int. Cl. G06F 17/00

(52) U.S. Cl. 463/25

(57) ABSTRACT

The invention is a system and method for eliminating the requirement for chips or tokens that are traditionally used in standard gaming.

### SUMMARY OF THE INVENTION

The invention is a chipless gaming system for placing, tracking, and payment of gaming-related wagers electronically. The invention is also a method for providing the same.

### The Inventive System

The chipless gaming system, according to the principles of the invention, is used for placing, tracking, and payment of gaming related wagers electronically. The system includes a plurality of player stations adjacent a player table. Each player station has a card reader that is adapted to read a money card. Each money card will have data stored electrically thereon, much like a debit card, credit card, or common ATM card.

The player station will also include an interface enabling a player to selectively enter wagering information, and a display that enables each player to view information that pertains to important gaming data. For example, the display will enable a player to view ones current balance, as read from the money card, or current wager information, or any other data that would be important for a player to know.

The system will also include a plurality of indicator buttons that enable the player to selectively indicate desired player option with respect to the current game. For example, the player options are at least one of: a desired wager; an option to double down in the current game; an option to split in the current game; and/or an option to give the dealer a tip.

The inventive system will also include a display that enables the dealer to view and inspect wagering information that pertains to each respective player at the table. The dealers display will also include a lock button that enables the dealer to eliminate the ability of a player to further exercise a respective desired playing option until the game or hand is completed. The dealer's station will also include a plurality of buttons enabling the dealer to selectively enter, for each player, whether a respective outcome for each respective player of the game upon its completion. The system will also include a communication link, such as an electronic or electrical link, between the dealer board and each viewable player board. Upon completion of each hand, the communication link functions to update each respective player's balance corresponding with the outcome of the game that had just been completed.

The chipless gaming system can be used with any common casino game, such as Blackjack, Three Card Poker, Let It Ride, or Caribbean Stud Poker. In fact, the inventive system is quite versatile and able to accommodate numerous common casino games.

The inventive system may also include a cash out indicator position adjacent each player board. When a player selects the cash out indicator, the player's money card may be updated with information regarding the respective player's current balance at the time of cash out.

Optionally, the inventive system may include a slot positioned adjacent to the player board. This slot should be configured to receive either cash that is selectively entered by the respective player, or a special money card that may be used by a particular casino for the purpose of accounting for a player's funds spent at a particular casino.

If desired, a player may add to his or her individual balance by inserting cash, a playing ticket, or a money card into a slot. In a preferred embodiment of the system, the player station will include a slot having the ability to perform an ATM transaction and receive a player's PIN number so that a player may obtain cash without leaving the table.

The inventive system may also include a plurality of indicator buttons that allow the player the option of placing a side bet into a special side bet ante pool. In general, side bets are known in the art and allow each player to engage in a second game that is independent of the primary game taking place. If a side bet condition is met, the first player to meet said condition will instantly be given credit for the funds in the side bet ante pool.

In another embodiment of the system, a plurality of gaming tables are linked in communication with the side bet ante pool so that all players at each of the plurality of tables contribute to the side bet ante pool.

In that regard, the inventive system will also include a side bet victory button that enables the dealer to selectively indicate whether a player has met a criteria necessary to meet this side bet. Immediately upon confirmation that a player has won the side bet, the dealer selects the button, thereby entitling the respective player to the side bet ante pool period.

### The Inventive Method

The invention is also a method of placing, tracking, and paying game wagers electronically without requiring chips or tokens. The method will include the steps of providing a game table with a plurality of player stations positioned adjacent to playing table, and furnishing each player station with a card reader adapted to read a money card having data stored thereon. The inventive method will also include a step of providing an interface enabling each player to selectively enter information regarding the player's chosen gaming options, and then displaying to the player information pertaining to the player's current balance, as read from the money card. The inventive system will also include the step of displaying, to the player, information pertaining to the currently exercised gaming options, and selectively indicating, by each player the playing options with respect to a current game. The playing options will include, but are not limited to, a desired wager; an option to double down in the current game; an option to split in the current game; and, an option to give the dealer a tip.

The inventive method will also include the step of positioning a dealer station adjacent to playing table and displaying, to the dealer, the wagering information selected by each respective player at the table. The inventive method will also include the step of eliminating, by the dealer, the ability of a player to further exercise the respective desired playing options until the completion of a game. The inventive method will also include the step of playing and completing the game, then selectively entering, by the dealer at the completion of the game, a respective outcome for each player of the game.

The inventive method will also include the step of communicatively connecting the dealer board with each player board so that the player options are viewable on the dealer board, and information selected by the dealer is transmitted to each respective player board. The inventive method will also include the step of updating each respective player's balance based upon information input by the dealer during this selectively entering step period.

Optionally, the inventive method will include the step of positioning a cash out indicator adjacent to each player board then selecting, by the player, the cash out indicator, and updating the respective selecting player's current balance at the time of the cash out.

The method may also comprise the step of positioning a slot within the player board, and configuring the slot to receive cash that is selectively entered by the respective player. Additionally, the inventive method may also include the step of updating the respective player's current balance by corresponding amount of the cash inserted into slot.

The inventive method may also include the step of allowing at least one of the players the option to participate in a side bet. A player may participate in a side bet by contributing funds into a special ante pool in hopes that a criteria would be met by hands that are dealt during the game. A specific embodiment of this method may include the steps of providing a plurality of gaming tables wherein the plurality of gaming tables are communicatively interconnected with this side bet ante pool. This allows the side bet ante pool to grow at a much faster rate than it would if only one table were contributing to the same.

In another embodiment or variation of this progressive embodiment of the invention, the inventive system may include the step of communicatively connecting a plurality of gaming tables that are positioned in distinct buildings. Further, the distinct buildings may actually be in casinos located in different cities.

The inventive method may also include the step of enabling the dealer to selectively indicate whether a player has met the criteria necessary to meet the side bet. Additionally, the inventive method may include the step of paying, by the dealer, the entire side bet ante pool immediately to the first player who meets a side bet criteria.

The inventive method may also include the step of creating the money card to be a credit card, debit card, ATM card, or a casino-specific card containing electronic data regarding the player's money balance. Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view showing a gaming table and player stations of the chipless gaming system and method, according to the principles of the invention.

FIG. 2 is an isolated view focusing upon the aspects of the player station, according to the principles of the invention.

FIG. 3 is an isolated view showing the dealer's station, according to the principles of the invention.

FIG. 4 is an isolated view of a dealer authorization station.

FIG. 5 is a perspective view showing the network of a plurality of gaming tables, according to the principles of the invention.

### DETAILED DESCRIPTION OF THE PREFERRED EMBODIMENTS

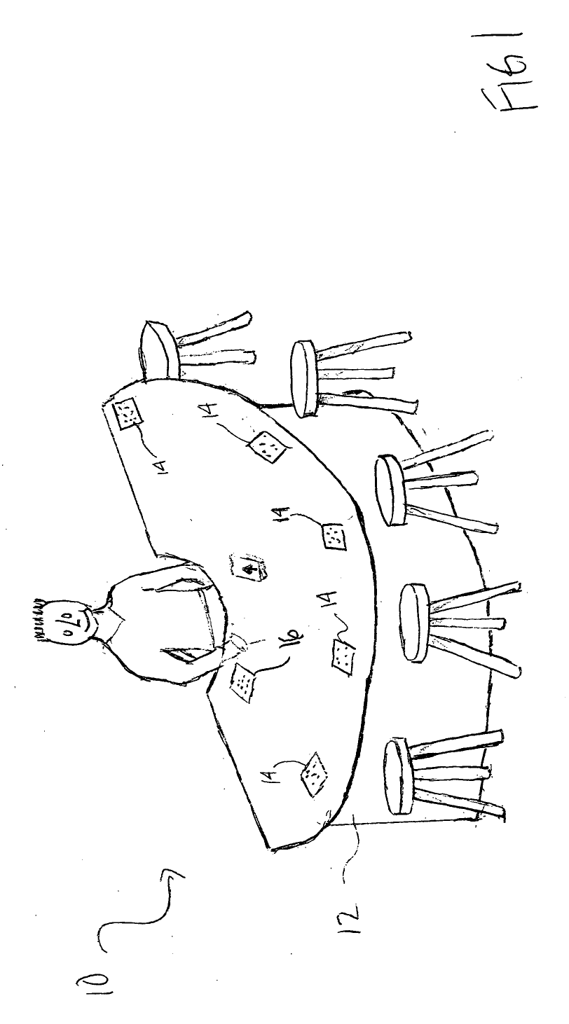

FIG. 1 is a perspective view of the inventive system 10 including a gaming table 12 and a plurality of player stations 14. A dealer station 16 is positioned on an opposing side of the table 12.

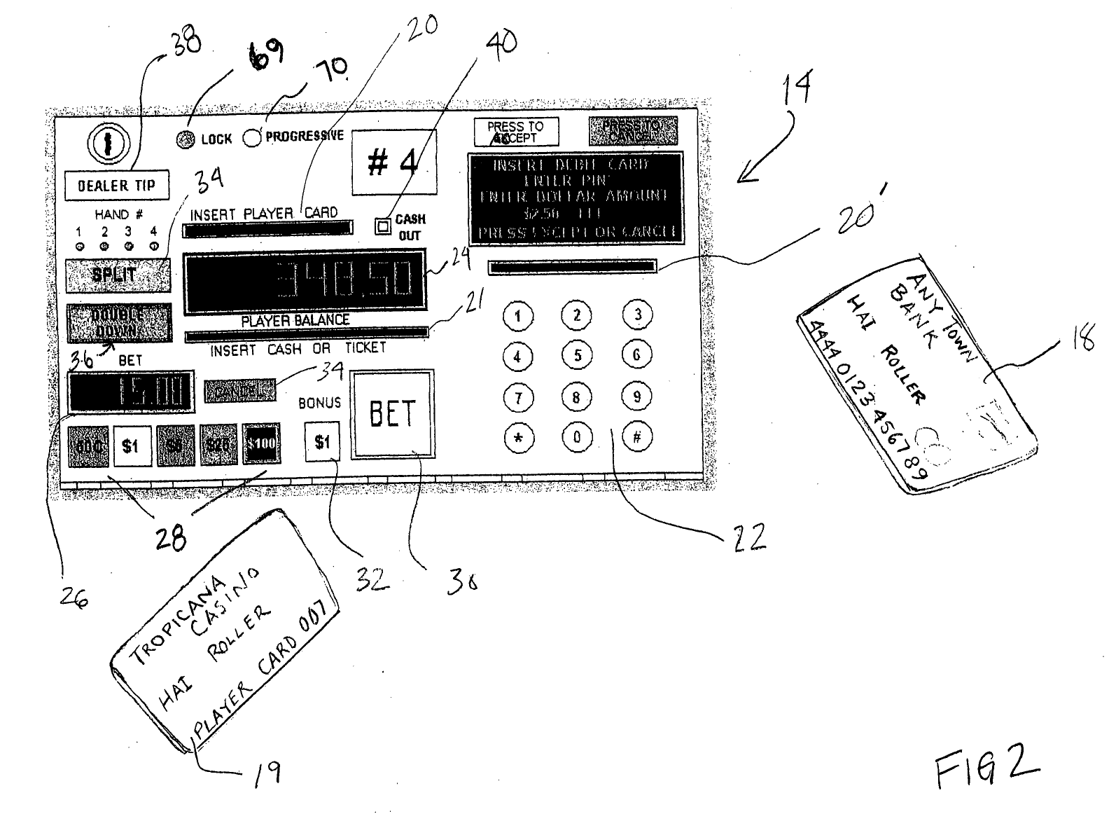

FIG. 2 shows an isolated view giving the details of the player station 14. The player station 14 will include a card slot 20 configured to receive a player money card 19. The player's balance is displayed on balance display 24, and the player's present bet or wager is shown on bet display 26.

As shown in FIG. 2, a plurality of wager buttons 28 allow the player to input his desired wager on the current hand, and the bet button 30 can be depressed when the player has selected his desired bet. Optionally, a bonus button 32 is positioned on the player station 14; this button may be used to participate in a side bet game, or any extra wager, as called for in the rules of the respective game presently being played.

Still referring to FIG. 2, the player station 14 will also include a split button 34, and a double down button 36. Because Blackjack is perhaps one of the most popular casino games across the nation, these optional buttons may be included within the player station 14 in order to indicate a player's option to exercise these strategic moves. The player station 14 may also include a cash or ticket slot 21 for receipt of money or a ticket or card (such as computer read punch card or magnetically-read casino-specific instrument) in order to update the player's balance, which will be shown on player balance display 24.

Still referring to FIG. 2, the player station 14 may also include an on-site ATM or cash machine that includes a slot 20′ and keypad 22. In this embodiment, the slot 20′ is configured to receive a money card 18, such as a credit card, debit card, or ATM card. This feature of the player station 14 provides the player an opportunity to remain at his player station 14, even though he requires more funds to play the game. Under previous forms, a player needing more funds or chips would be required to cash out, leave the table, and purchase more chips at the cashier's station, or visit an ATM machine located remotely from the table. This feature of the player station 14 enables a player requiring additional funds to remain at his place at the table. Preferably, the ATM setup is not connected to the playerboard to share information, so the dealer is generally not authorized to credit or debit a player using the ATM. The slot 20′ for the money card 18 allows a player to access a selected bank account so that a player may purchase game credits from a dealer. Upon leaving the table, the player station 14 may emit a ticket displaying cash credits due a player.

Still referring to FIG. 2, the player station 14 will include a lock display 69 indicating that the dealer has foreclosed further betting and wagering activity. Player station 14 may also include a progressive indicator 70 that can selectively indicate the dealer's confirmation that a respective player is participating in a side bet game, especially a progressive side bet game.

It is common practice for players to tip a good and efficient dealer. As shown in FIG. 2, the player station 14 of the chipless gaming system 10 has a dealer tip indicator 38 enabling a player to selectively extend a gratuity to the dealer.

As shown in FIG. 2, the player station 14 may also include a cash out indicator 40 that may be selectively depressed by the player in order to indicate the player's desire to cease playing. Upon selection of the cash out indicator 40 the chipless gaming system 10 will update the player's balance. The step of updating the player's balance may occur by inputting this information directly onto the player card 19, or by expelling a ticket from slot 21 that may be read at a separate, remote cashier's station.

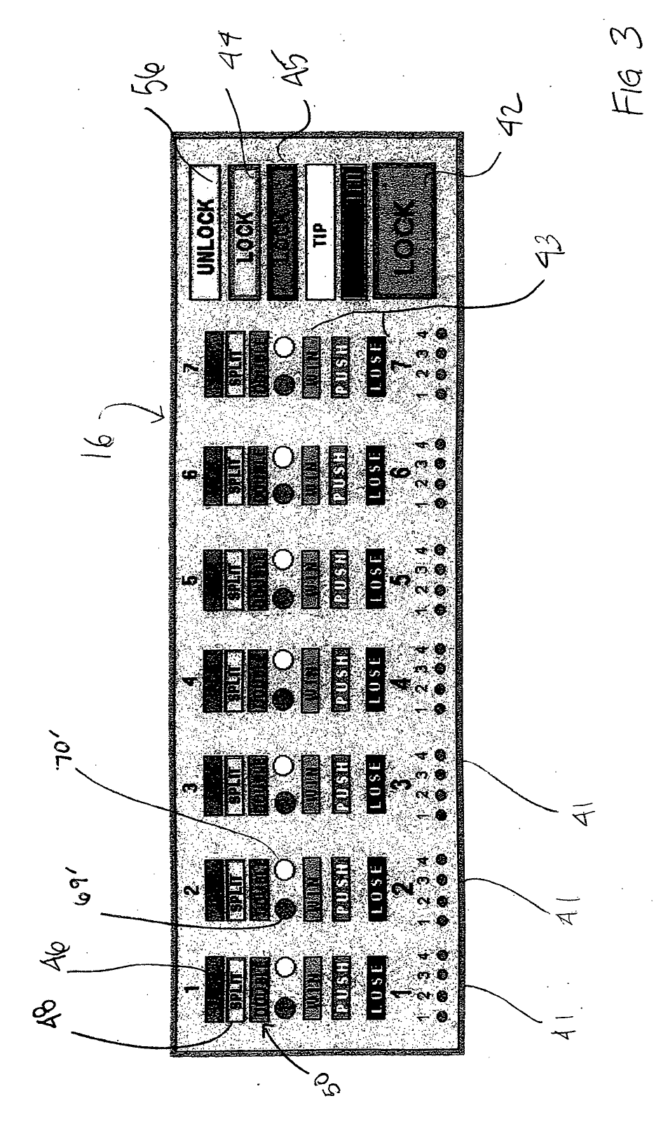

FIG. 3 shows an isolated view of the dealer station 16. The dealer station 16 will include a plurality of respective player columns 41, each respective player column 41 bearing a respective numeral corresponding to a respective player station 14 (as shown in FIG. 1). Each of the dealer stations 16 will also include a respective outcome indicator 43 wherein the dealer can confirm, at the conclusion of a hand, whether a respective player has won, lost, or pushed the hand with the dealer.

Still referring to FIG. 3, each dealer station 16 will also include a split indicator 48, and a double down indicator 50. Each respective player column 41 may also include a lock display indicator 69′ and a progressive/side-bet indicator 70′. When a respective player indicates a desire to split, or double, a particular hand, this information is transferred from the player station 14 (as shown in FIGS. 1, 2) to the dealer station 16 by means of the respective indicators 48, 50. It should be noted that the indicators 48, 50 on the dealer station 16 will provide identical data as respective indicators 34, 36 (as seen in FIG. 2) on respective player stations 14. As the dealer confirms that a respective player has a hand qualifying for a split or double, the dealer then selectively depresses the split 48 and/or double 50 indicator within the appropriate, respective player column 41 of the dealer station 16. The dealer station may also include an unlock indicator 56. The unlock indicator 56 will most commonly be used to open the dealer board to accept bets by players for a new game. Also, the unlock indicator can be selected to enable the dealer to override or undo any inadvertent locking of data, yet at the same time preserve the integrity and security of the performance of the game.

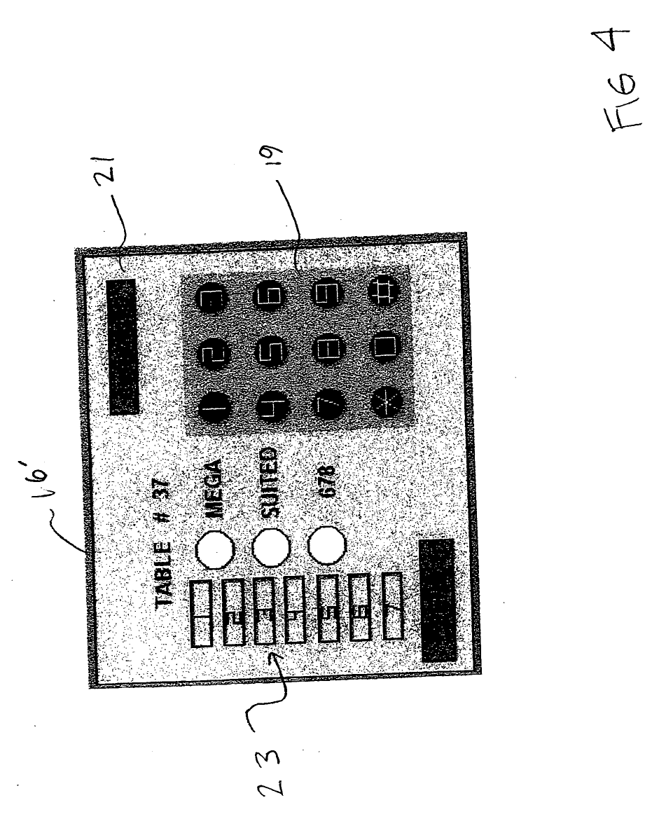

FIG. 4 shows a detailed view of a dealer authorization station 16′ that may be part of the traditional dealer station 16 (as shown in FIG. 3), or may be positioned adjacent the dealer station 16. The keypad 19 of the dealer authorization station 16′ is used in order to override an error or omission, or to authorize the immediate credit/payment to a winning player at the dealer's table. The display 21 is positioned adjacent the keypad 19 in order to confirm the processing of a request that is input into the keypad 19.

Still referring to FIG. 4, the dealer authorization station 16′ may also include a display 23 that enables the dealer to observe which players, if any, are participating in side-bet or progressive games. Side bets are now well known in the gaming community, and many players commonly forgo participation in the side bet games, while many veteran gamers find the opportunity to enhance earnings and winnings quite attractive. It is preferred to position a dealer authorization station 16′ adjacent each dealer station 16, and at each table 12 (as shown in FIG. 1)

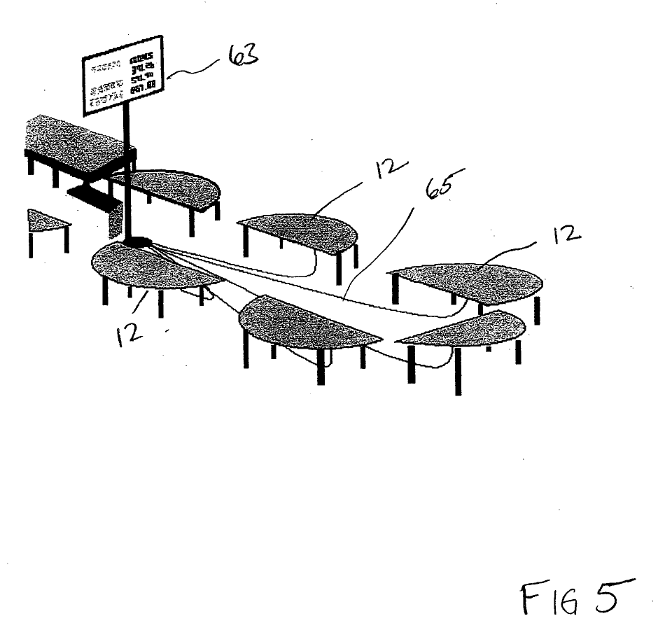

FIG. 5 shows a perspective view of a primary embodiment of the invention wherein a plurality of gaming tables 12 are in communication with one another by means of an interconnection 65 that further interconnects the gaming tables 12 with a side bet ante pool 63, the balance of which can be displayed to each player. Optionally, the plurality of gaming tables 12 that are interlinked may be communicatively linked with tables remotely positioned, such as in another building or in another city entirely.

Although the invention and the drawings are described in detail, this description has been made for illustrative and example purposes only. The scope and breadth of the described invention is limited only by the terms of the appended claims.

1. A chipless gaming system for placing, tracking, and payment of gaming-related wagers electronically, the system comprising:
a plurality of player stations adjacent a playing table, each player station having a card reader adapted to read a money card having data stored thereon;
an interface enabling a player to selectively enter wagering information;
a display enabling the player to view information pertaining to at least one of the player's current balance, as read from the money card, or information pertaining to a current wager information;
a plurality of indicator buttons enabling the player to selectively indicate a desired player option with respect to a current game, said options being at least one of:
a desired wager;
an option to double down in the current game;
an option to split in the current game;
an option to give the dealer a tip;
a dealer station positioned adjacent the playing table and including
a display enabling the dealer to view wagering information pertaining to each respective player at the table;
a lock button enabling the dealer to eliminate the ability of a player to further exercise the respective desired playing options until completion of a game;
a plurality of buttons enabling the dealer to selectively enter, for each player, whether a respective outcome for each respective player of the game upon its completion;
wherein, each respective player board is in communication with the dealer board so that the player options are viewable on the dealer board, and information selected by the dealer is transmitted to each respective player board to the player's balance.

2. The system as in claim 1, further comprising a cash out indicator positioned adjacent each player board; and wherein,
upon a player selecting the cash out indicator, a cash-out ticket with information regarding the respective player's current balance at the time of cash out is issued to the respective player.

3. The system as in claim 1, further comprising a cash out indicator positioned adjacent each player board; and wherein,
upon a player selecting the cash out indicator, the player's money card is updated with information regarding the respective player's current balance at the time of cash out.

4. The system as in claim 1, further comprising a slot positioned within the player board, the slot configured to receive cash that is selectively entered by the respective player.

5. The system as in claim 4, wherein the player's current balance is updated by a corresponding amount when the player inserts cash into the slot.

6. The system as in claim 1, the plurality of indicator buttons further including indicator buttons that allow a player the option of placing a side bet into a special side bet ante pool.

7. The system as in claim 6, further comprising
a plurality of gaming tables; wherein,
each gaming table is in communication with the side bet ante pool.

8. The system as in claim 7, wherein the plurality of gaming tables that are in communication with the side bet ante pool are positioned in distinct buildings.

9. The system as in claim 8, wherein the distinct buildings are in different cities.

10. The system as in claim 6, further comprising
a side bet victory button enabling the dealer to selectively indicate whether a player has met a criteria necessary to win the side bet; wherein,
selection of the side bet victory button immediately entitles a player meeting the side bet criteria to the side bet ante pool.

11. The system as in claim 1, wherein the money card is one of a credit card, a debit card, or an ATM card.

12. The system as in claim 1, wherein the game is one of three card poker, blackjack, let it ride, or Carribean stud poker.

13. A method of placing, tracking, and paying gaming wagers electronically without requiring chips or tokens, the method including the steps of:
providing a gaming table with a plurality of player stations adjacent a playing table;
furnishing each player station with a card reader adapted to read a money card having data stored thereon;
providing an interface that enables each player to selectively enter information regarding the player's chosen gaming options;
displaying, to the player, information pertaining to at least one of the player's current balance, as read from the money card;
displaying, to the player, information pertaining to currently-exercised gaming options;
selectively indicating, by each player, the playing options with respect to a current game, said playing options being at least one of:
a desired wager;
an option to double down in the current game;
an option to split in the current game;
an option to give the dealer a tip;
providing a dealer station positioned adjacent the playing table;
displaying, to the dealer, the wagering information selected by each respective player at the table;
eliminating, by the dealer, the ability of a player to further exercise the respective desired playing options until completion of a game;
playing and completing the game;
selectively entering, by the dealer at the completion of the game, a respective outcome for each respective player of the game;
communicatively connecting the dealer board with each player board so that the player options are viewable on the dealer board, and information selected by the dealer is transmitted to each respective player board; and,
updating each respective player's balance based upon information input by the dealer during the selectively entering step.

14. The method as in claim 13, further comprising the steps of
positioning a cash out indicator adjacent each player board;
selecting, by at least one player, the cash out indicator;
updating the respective selecting player's current balance at the time of cash out.

15. The method as in claim 13, further comprising the step of positioning a slot within the player board; and, configuring the slot to receive cash entered by the respective player.

16. The method as in claim 15, further comprising the step of updating a respective player's current balance by a corresponding amount cash is inserted into the slot.

17. The method as in claim 13, further comprising the step of allowing the at least one player an option to place a side bet into a special side bet ante pool.

18. The method as in claim 17, further comprising the steps of
providing a plurality of gaming tables; wherein,
communicatively interconnecting each of the plurality of gaming tables with the side bet ante pool.

19. The method as in claim 18, wherein selected tables of the plurality of gaming tables that are in communication with the side bet ante pool are positioned in distinct buildings.

20. The method as in claim 19, wherein the distinct buildings are in different cities.

21. The method as in claim 18, further comprising the steps of
enabling the dealer to selectively indicate whether a player has met a criteria necessary to meet the side bet; and
immediately paying the side bet ante pool to a first player who meets the side bet criteria.

22. The method as in claim 13, wherein the money card is one of a credit card, a debit card, or an ATM card.
